(19) United States
(12) Patent Application Publication
(10) Pub. No.: US 2022/0410395 A1
(43) Pub. Date: Dec. 29, 2022

(54) INFORMATION PROCESSING APPARATUS, INFORMATION PROCESSING METHOD, DISPLAY DEVICE, DISPLAY METHOD, ROBOT SYSTEM, ARTICLE MANUFACTURING METHOD, AND RECORDING MEDIUM

(71) Applicant: CANON KABUSHIKI KAISHA, Tokyo (JP)

(72) Inventors: Satoshi Sugaya, Kanagawa (JP); Hironobu Sasaki, Kanagawa (JP)

(21) Appl. No.: 17/847,071

(22) Filed: Jun. 22, 2022

(30) Foreign Application Priority Data
Jun. 24, 2021 (JP) 2021-104985

(51) Int. Cl. B25J 9/16

(52) U.S. Cl. CPC B25J 9/1671; B25J 9/1605; B25J 9/1612

(57) ABSTRACT

An information processing apparatus including a display unit configured to display a state of a robot system based on first data is characterized in that at least one element of the robot system based on the first data can be outputted with second data that is different from the first data.

### BACKGROUND

### Field of the Disclosure

The present disclosure relates to an information processing method and an information processing apparatus.

### Description of the Related Art

Robot simulators have been used for robot configuration (also referred to as teaching) of setting up robot's motions. With the help of robot simulators, robot's motions can be checked in advance without using actual robotic machines. The robot configuration includes, for example, setting a tool center point (hereinafter referred to as TCP), which is the representative point of an end effector of a robot, and creating a program for causing a robot to move by using the TCP and generated teaching points that are each indicated by the coordinates of a position to which the TCP is to move. With the known robot simulators, it is possible to set the TCP of a robot and generate teaching points corresponding to motions to be made by the robot in a virtual space in which models including the robot, its end effector, peripheral devices, and operational targets are arranged. It is also possible to create a program indicating sequences of motions by using the TCP and teaching points generated by the robot simulator, and emulate and check the robot's motions in the virtual space.

In the robot configuration, however, the more operational targets there are, the more teaching points are created. The robot configuration is thus likely to be extremely complex. Further, when the layout of an operational target is changed after a corresponding teaching point is set, it is necessary to change the teaching point to match the layout of the operational target. To facilitate these operations, International Publication No. 2019/064914 (Patent literature 1) discloses a technology of moving teaching points together with models targeted for simulation by managing the models and teaching points associated with each other in the form of hierarchical data, in other words, by using a tree diagram (tree structure). With this technology, when the layout of an operational target is changed, a corresponding teaching point is moved together with the operational target. As a result, the need for the change operation is eliminated.

### SUMMARY

According to the present disclosure, an information processing apparatus including a display unit configured to display a state of a robot system based on first data is characterized in that at least one element of the robot system based on the first data can be outputted with second data different from the first data.

Further features of the present disclosure will become apparent from the following description of exemplary embodiments with reference to the attached drawings.

### BRIEF DESCRIPTION OF THE DRAWINGS

FIG. 1 schematically illustrates a robot system according to one or more aspects of the present disclosure.

FIG. 2 schematically illustrates a robot arm body according to one or more aspects of the present disclosure.

FIG. 3 schematically illustrates an information processing apparatus according to one or more aspects of the present disclosure.

FIG. 4 is a control block diagram of the information processing apparatus according to one or more aspects of the present disclosure.

FIG. 5 illustrates a virtual space according to one or more aspects of the present disclosure.

FIG. 6 illustrates an example of a simulation screen according to one or more aspects of the present disclosure.

FIG. 7 is a control flowchart according to one or more aspects of the present disclosure.

FIG. 8 is a control flowchart according to one or more aspects of the present disclosure.

FIG. 9 illustrates an example of the simulation screen according to one or more aspects of the present disclosure.

FIG. 10 illustrates an example of a selection screen according to one or more aspects of the present disclosure.

FIG. 11 illustrates an example of a tool center point (TCP) selection screen according to one or more aspects of the present disclosure.

FIG. 12 illustrates an example of the simulation screen according to one or more aspects of the present disclosure.

FIG. 13 illustrates an example of a selection screen according to one or more aspects of the present disclosure.

FIG. 14 illustrates an example of the selection screen according to one or more aspects of the present disclosure.

FIG. 15 illustrates an example of the selection screen according to one or more aspects of the present disclosure.

FIG. 16 illustrates an example of a simulation screen according to one or more aspects of the present disclosure.

FIG. 17 illustrates an example of the simulation screen according to one or more aspects of the present disclosure.

FIG. 18 illustrates an example of the simulation screen according to one or more aspects of the present disclosure.

FIG. 19 illustrates an example of a simulation screen according to one or more aspects of the present disclosure.

FIG. 20 illustrates an example of a selection screen according to one or more aspects of the present disclosure.

FIG. 21 illustrates an example of the simulation screen according to one or more aspects of the present disclosure.

### DESCRIPTION OF THE EMBODIMENTS

International Publication No. 2019/064914 describes that, with its technology, models targeted for simulation and teaching points are managed by being associated with each other in the form of hierarchical data, based on data of a given virtual space. International Publication No. 2019/064914, however, does not describe the case of applying the hierarchical data generated based on the data of the given virtual space data to data of another virtual space. One example of the above case is that, when hierarchical data composed of elements including teaching points corresponding to operational targets is created with a robot of Company A on data of a given virtual space, simulation may be expected to be conducted with a robot of Company B by using the hierarchical data on data of another virtual space. International Publication No. 2019/064914, however, does not describe the case of applying hierarchical data created based on data of a given virtual space to different data with its technology, and thus, it is necessary to reconfigure teaching points corresponding to operational targets, based on data of another virtual space.

In consideration of the above problems, the present disclosure provides an information processing apparatus capable of handling created elements targeted for simulation on different data.

Hereinafter, embodiments of the present disclosure will be described with reference to the accompanying drawings. The following embodiments are mere examples, and those skilled in the art can change, for example, details of configurations as appropriate without departing from the spirit and scope of the disclosure. The numerical values presented in the embodiments are for reference only, and the present disclosure is not limited to the presented numerical values. In the drawings, arrows X, Y, and Z indicate the coordinate system of an entire robot system. In general, the three-dimensional XYZ coordinate system represents the world coordinate system of an entire setting environment. In some cases, local coordinate systems may be used when appropriate for particular parts such as a robot hand, fingers, and joints for the sake of, for example, convenience of control.

### First Embodiment

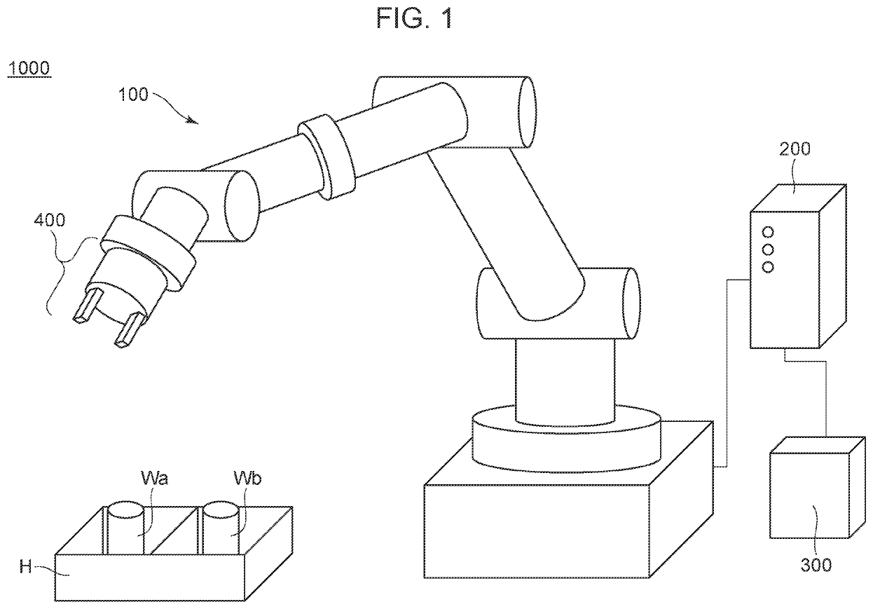

The following describes an embodiment of the present disclosure in detail with reference to the drawings. FIG. 1 illustrates a robot system 1000 according to the embodiment. The robot system 1000 includes a robot arm body 100 as an actual machine, a control device 200, and an information processing apparatus 300.

The robot arm body 100 is an industrial robot and used to manufacture articles. The robot arm body 100 includes a robot hand body 400, which is an example of an end effector. The robot arm body 100 is positioned on, for example, a stand or a floor surface, which are not illustrated in the drawings.

Close to the robot arm body 100, a workpiece Wa and a workpiece Wb, which are target objects, are stored in a box H. The robot hand body 400 is a tool for grasping the workpiece Wa or Wb.

The control device 200 controls the robot arm body 100 in accordance with motion information about the robot arm body 100 and the robot hand body 400, in other words, teaching data representing a robot program. The control device 200 obtains the teaching data from the information processing apparatus 300.

The teaching data includes information about commands and information about teaching points. In the present embodiment, the control device 200 controls the robot arm body 100 and the robot hand body 400 in accordance with the teaching data so that the robot arm body 100 holds either one of the workpieces Wa and Wb.

As a result, for example, by performing assembly operation with the workpiece Wa and the workpiece Wb as materials, assembled workpieces can be manufactured as products. As such, articles can be manufactured by using the robot arm body 100.

The information processing apparatus 300 is implemented by a computer. The information processing apparatus 300 operates as a teaching device, that is, a simulator. In the present embodiment, the information processing apparatus 300 generates teaching data by computer simulation, that is, off-line teaching. The teaching data generated by the information processing apparatus 300 is output to the control device 200. The method of outputting teaching data to the control device 200 is not limited to any particular manner. For example, the teaching data generated by the information processing apparatus 300 may be outputted to the control device 200 by wired or wireless communication, or via a storage device not illustrated in the drawings.

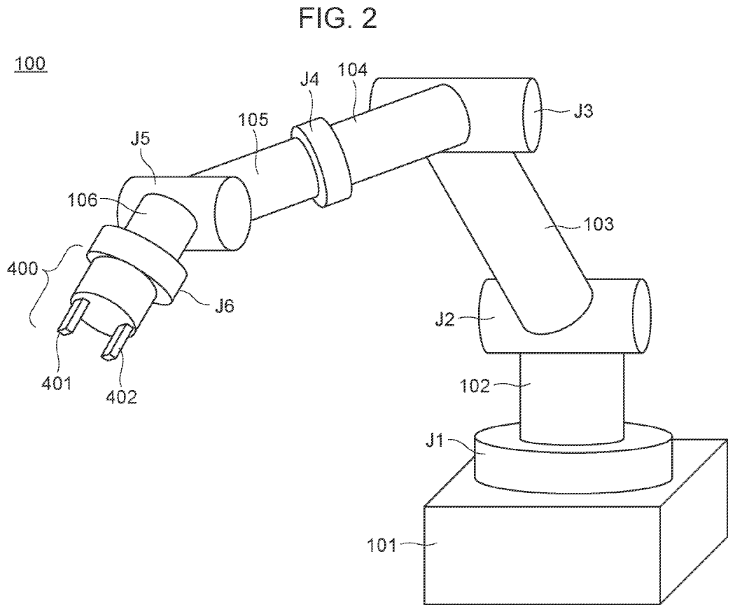

FIG. 2 illustrates the robot arm body 100 and the robot hand body 400 according to the present embodiment. The robot arm body 100 is, for example, a vertically articulated robot arm. A pedestal 101, which is the base of the robot arm body 100, is fixed to a stand or a floor surface, which are not illustrated in the drawing. The robot hand body 400 is attached to a joint link J6, which is the distal end of the robot arm body 100. The robot arm body 100 includes the pedestal 101, a plurality of links 102 to 106, and joint links J1 to J6 each having a power source for operating the robot hand body 400. These pedestal 101, the links 102 to 106, and the robot hand body 400 are joined to each other by the joint links J1 to J6, so that the links 102 to 106 and the robot hand body 400 are rotatable with the help of the joint links J1 to J6.

The joint links J1 to J6 each include a motor as a power source, which is not illustrated in the drawing. The robot arm body 100 can pose in various manners such that the motors (not illustrated) provided in the joint links J1 to J6 respectively rotate the links 102 to 106 and the robot hand body 400 in the direction of circumference of the joint links J1 to J6.

The robot hand body 400 is configured to move fingers 401 and 402 close to or away from each other. The robot hand body 400 includes inside a motor for actuating the fingers 401 and 402, which is not illustrated in the drawing. This motor causes the fingers 401 and 402 to move close to or away from each other. The present embodiment describes as an example the case of grasping a workpiece (target object) by fingers, but this should not be construed in a limiting sense. For example, an air suction mechanism may also be used.

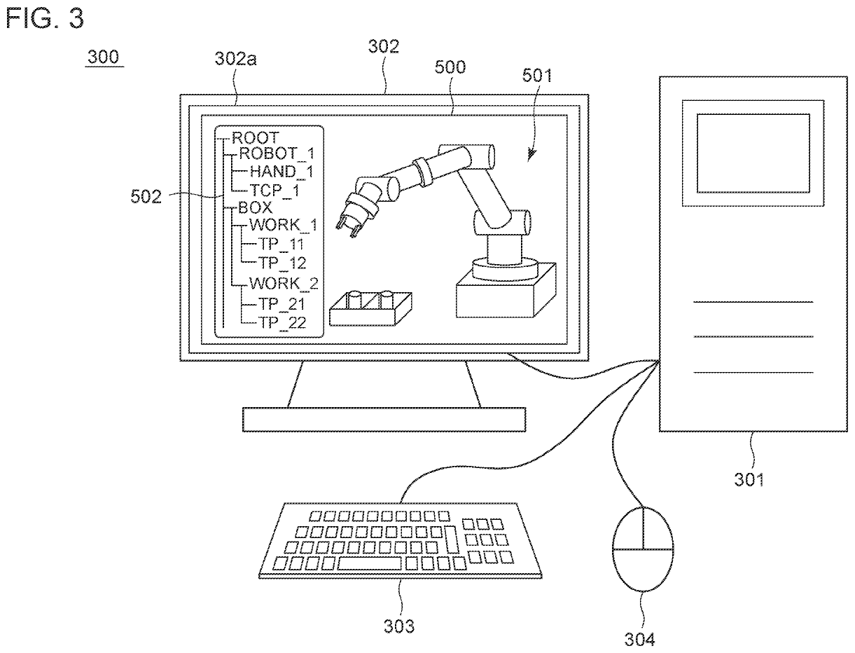

FIG. 3 illustrates the information processing apparatus 300 according to the embodiment. The information processing apparatus 300 includes an apparatus main body 301, a display 302, which is an example of a display device connected to the apparatus main body 301, and a keyboard 303 and a mouse 304, which are an example of an input device connected to the apparatus main body 301. The following description uses as an example the case in which the information processing apparatus 300 is a desktop personal computer (PC), which is a general-purpose computer, but this should not be construed in a limiting sense. The information processing apparatus 300 may be, for example, a general-purpose computer such as a laptop PC, a tablet PC, or a smartphone, or may be a teach pendant or a computer especially for a simulator. The information processing apparatus 300 may be incorporated into the control device 200. This means that the control device 200 may have a function of a simulator.

On the display 302 for performing display, a display unit 302a displays images used by the user to teach the robot system 1000 and edit a program for controlling the robot system 1000. The display unit 302a may be formed by arranging a touch panel on its surface. In this case, the touch panel can be used for input operations similar to input operations performed with input devices such as the keyboard 303 and the mouse 304, and as a result, the input devices may be removed from the configuration in given cases.

The display unit 302a displays a simulation screen 500 for checking motions of the robot system 1000 after teaching and program editing. The information processing apparatus 300 of the present embodiment is configured to teach a robot arm and a robot hand mainly in an offline environment, rather than in an online environment in which the information processing apparatus 300 is connected to an actual robot system to cause a robot arm and a robot hand to move. Various kinds of information for the simulator of the robot system can be inputted, edited, and changed by the input devices such as the keyboard 303 and the mouse 304.

The simulation screen 500 in FIG. 3 includes at least a virtual space screen 501 and a management screen 502. The virtual space screen 501 and the management screen 502 can be created as graphical user interfaces (GUIs). In this case, a pointing device such as the mouse 304 (or the touch panel described above) can be used to operate with objects (for example, a menu, input fields for numerical values and texts, and virtual robot representations) constituting the simulation screen 500.

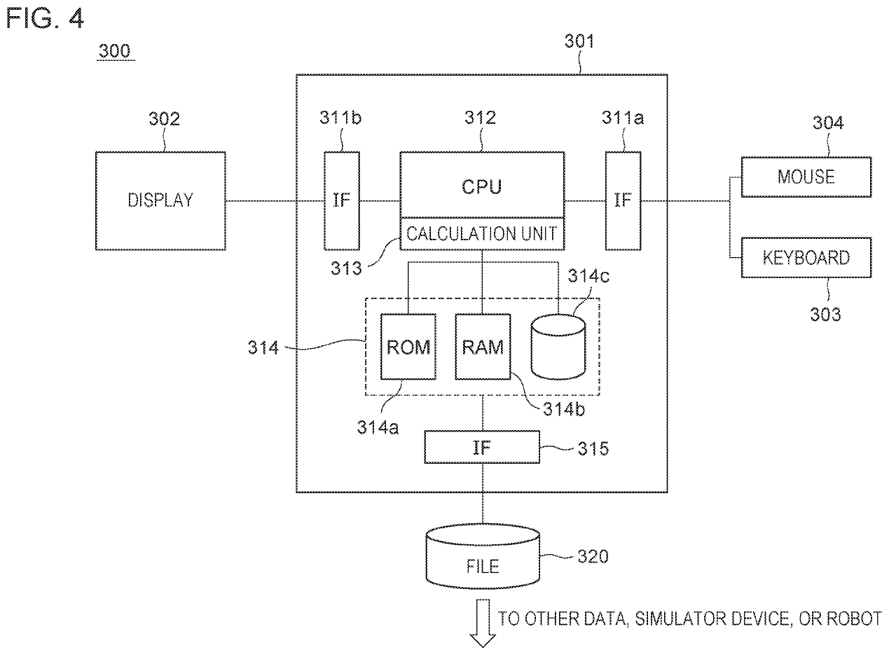

FIG. 4 is a control block diagram illustrating a control system of the information processing apparatus 300. As illustrated in FIG. 4, the apparatus main body 301 of the information processing apparatus 300 includes as hardware a central processing unit (CPU) 312 and a storage device 314 constituted by units including a read-only memory (ROM) 314a, a random-access memory (RAM) 314b, and a hard disk drive (HDD) 314c.

The apparatus main body 301 further includes an interface 311a for communicating and establishing connection with the input devices such as the mouse 304 and the keyboard 303 and an interface 311b for communicating and establishing connection with the display 302. The apparatus main body 301 also includes an interface 315 for exchanging data in the form of, for example, a file 320 with external devices such as other simulator devices and robotic devices. These interfaces are each implemented by, for example, a serial bus, a parallel bus, or a network interface.

The ROM 314a is a non-transitory storage device. The ROM 314a stores basic programs that are read by the CPU 312 when the computer starts. The RAM 314b is a temporary storage device used by the CPU 312 for processing operations. The HDD 314c is a non-transitory storage device for storing various kinds of data including results of processing operations by the CPU 312.

In the present embodiment, the HDD 314c stores a program used as application software. By running this program, the CPU 312 functions as an information processing unit capable of simulating motions of a virtual robot and virtual workpieces in a virtual environment as described later.

In the present embodiment, the HDD 314c is a computer-readable non-transitory recording medium, and the HDD 314c stores the program as application software. However, this should not be construed in a limiting sense. Any computer-readable non-transitory recording medium can store this program. As a recording medium used to supply this program to the computer, for example, a flexible disk, an optical disk, a magneto-optical disk, a magnetic tape, or a non-volatile memory may be used.

The CPU 312 controls the entire system of the information processing apparatus 300. In FIG. 4, a calculation unit 313 is illustrated together with the CPU 312. The calculation unit 313 is actually a computation area used to run a control program configured to implement a control flowchart for performing calculation for control by the CPU 312, which will be described later.

The display 302 displays the simulation screen 500 in the form of GUI; the simulation screen 500 is constituted by, for example, the virtual space screen 501 and the management screen 502 described above. The simulation screen 500 receives user's GUI operations performed with, for example, the mouse 304 and the keyboard 303.

The CPU 312 causes the calculation unit 313 to perform calculation for control in accordance with input or edit operations performed with the mouse 304 or the keyboard 303. The calculation for control by the calculation unit 313 generates display control information for updating the presentation of the display 302 and also updates elements stored in the storage device 314.

The storage device 314 stores the virtual space screen 501 on the display 302, model information about models that are elements displayed in the management screen 502, and teaching information in the form of hierarchical data using (hierarchical) nodes. The hierarchical data using nodes stored in the storage device 314 is outputted and updated in response to requests from the CPU 312. Additionally, in response to requests from external devices or particular operations by the mouse 304 and the keyboard 303, the CPU 312 can control the storage device 314 to output, in the form of the file 320, the hierarchical data using nodes stored in the storage device 314 via the interface 315. The file 320 can be loaded from the outside via the interface 315 as needed.

For example, when the information processing apparatus 300 is started or restored, the file 320 previously outputted is loaded from external devices (external storage devices such as a solid state drive (SSD) and a network attached storage (NAS).

The storage device 314 is accordingly updated, so that the previous storage can be reproduced. In the present embodiment, elements can be stored in any storage area in the storage device 314; for example, a given area in the RAM 314b or a storage area (for example, an area corresponding to a given file) in the HDD 314c can be used. The above is an example of an overall configuration of the information processing apparatus 300.

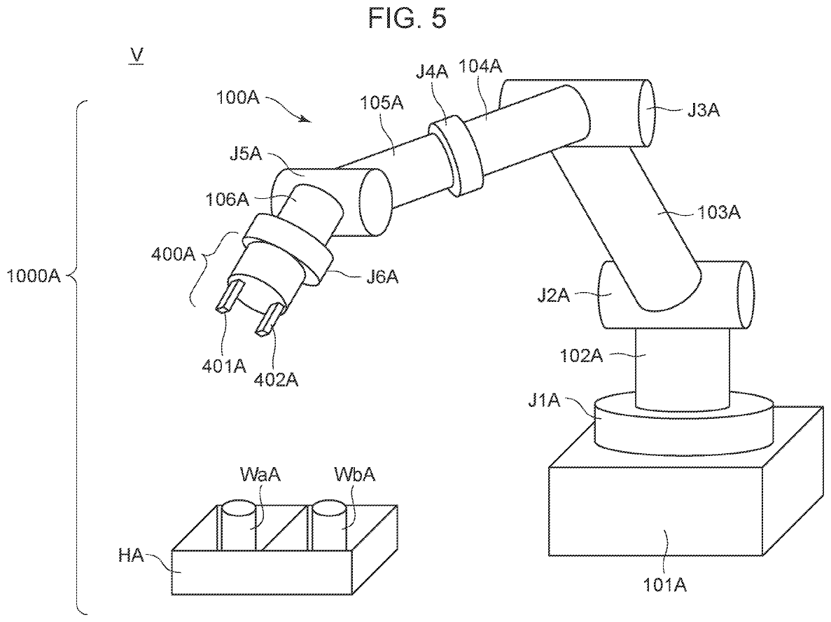

FIG. 5 illustrates a virtual space V, which is represented by first data, simulated by the information processing apparatus 300 according to the embodiment. The information processing apparatus 300 defines the virtual space V illustrated in FIG. 5 as a virtual environment. Virtual objects in the virtual space V are defined by three-dimensional model data, such as CAD data. In FIG. 5, virtual objects in the virtual space V are visualized as structures for convenience sake.

The following describes virtual objects defined in the virtual space V illustrated in FIG. 5. In the virtual space V, a virtual robot system 1000A is defined. The virtual robot system 1000A is defined by three-dimensional model data for imitating the robot arm body 100, the robot hand body 400, the workpieces Wa and Wb, and the box H illustrated in FIG. 1. A virtual robot arm body 100A includes a plurality of parts consisting of a virtual pedestal 101A, a plurality of virtual links 102A to 106A, and a plurality of virtual joint links J1A to J6A. To enable the virtual robot arm body 100A to realize the same motions as the robot arm body 100 illustrated in FIG. 1, the virtual links 102A to 106A are defined to be rotatable with the help of the virtual joint links J1A to J6A. A virtual robot hand body 400A is an example of a virtual end effector; in the present embodiment, the virtual robot hand body 400A is an example of a given part. Virtual fingers 401A and 402A are configured at the virtual robot hand body 400A.

In the virtual space V, virtual workpieces WaA and WbA, and a virtual box HA are defined close to the virtual robot arm body 100A. The virtual workpieces WaA and WbA, and the virtual box HA respectively imitate the workpieces Wa and Wb, and the box H illustrated in FIG. 1. The virtual workpieces WaA and WbA, and the virtual box HA are represented by three-dimensional model data. The CPU 312 simulates motions of grasping the virtual workpiece WaA or WbA by using the virtual robot arm body 100A and the virtual robot hand body 400A. The virtual space V illustrated in FIG. 5 is displayed as still or moving images on a display screen of the display 302 illustrated in FIG. 3.

Referring back to FIG. 3, in such a manner described above, the virtual space screen 501 displays a virtual environment as a reproduction of an arrangement environment similar to the actual robot system 1000 controlled by the control device 200 using teaching data transmitted from the information processing apparatus 300 to the control device 200. For example, the virtual space screen 501 displays the condition of the robot system by using 3D model representations such as 3D CAD models. The virtual space screen 501 also virtually displays 3D model representations indicating, for example, the coordinates of a tool center point (TCP) used as a control point to control the robot arm body 100 and the coordinates of teaching points. To update the display, 3D images are updated under the control of the display control function of the CPU 312 in accordance with information inputted with the input devices, subjected to rendering, and virtually displayed.

The RAM 314b and the HDD 314c of the storage device 314 described above are used as storage units for storing 3D data and position/orientation data of provided elements. For example, when one element depends on another element in the structure of the robot system, information items corresponding to these elements are stored as hierarchical data. The structure and details of this hierarchical data can be understood through, for example, the following description of the management screen 502.

In the present embodiment, the management screen 502 displays in the form of a hierarchical structure all elements necessary for simulation, represented by, for example, model information for virtual display using 3D model representations and teaching information about a TCP and teaching points necessary for controlling the robot arm body 100. On the management screen 502, model information of representations displayed on the virtual space screen 501, teaching information, elements not actually existing as 3D models (for example, a coordinate system and groups) are managed as information in the form of nodes, which is node management. The information managed in this state is displayed as a tree diagram (tree structure).

According to FIG. 3, the node management of the present embodiment uses a hierarchical data structure in which relations between a plurality of elements are represented by a hierarchical structure from the topmost root (higher level) determined as the absolute coordinate system (ROOT) to branches and leaves (lower level). In the hierarchical data of the present embodiment, a model close to the root (higher level) is referred to as a parent model, and a model close to leaves (lower level) is referred to as a child model. As information managed to define relations, relative value information indicating relationships between parent and child elements, that is, relative value information used as position/orientation data about a child element relative to a parent element is obtained. The information used as position/orientation data managed in the present embodiment is not limited to the relative value information. For example, absolute value information corresponding to the position and orientation of a particular child relative to the topmost parent may be stored.

To store data to manage elements with nodes in the present embodiment, data items of nodes are associated with each other together with, for example, address pointers and stored in the RAM 314b in the form of, for example, a linked list. Alternatively, when the data is stored in a file system on an external storage device such as an SSD or NAS, data storage methods of various relational database systems may be used.

In the present embodiment, the appearance of the management screen 502 is a visualized tree structure using nodes as elements stored on the storage device 314. At the same, it can be also considered that the management screen 502 displays a memory map of the tree-structured elements stored on the storage device 314. With the node management as described above, when the relative value information indicating the position and orientation of a parent model is changed, because the relative value information corresponding to the position and orientation of a child model relative to the parent model is retained, the child model can follow the parent model.

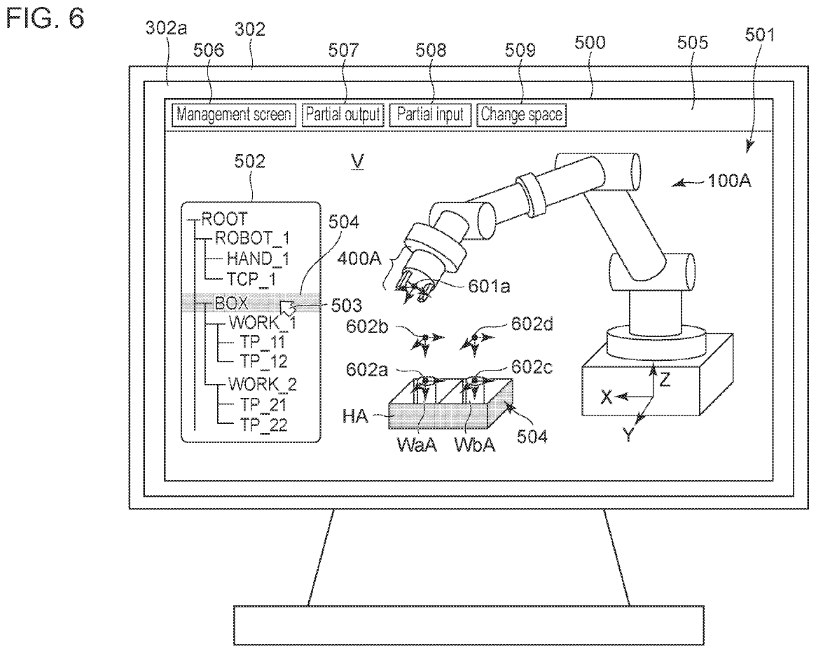

The following describes details of the simulation screen 500 according to the present embodiment. FIG. 6 illustrates the simulation screen 500.

Referring to FIG. 6, in the virtual space screen 501 of the simulation screen 500, the virtual robot arm body (ROBOT_1) 100A, the virtual robot hand body (HAND_1) 400A, and a TCP (TCP_1) 601a are displayed as model information. Additionally, the virtual box (BOX) HA and the two virtual workpieces (WORK_1, WORK_2) WaA and WbA as operational targets are displayed in the state in which the two virtual workpieces (WORK_1, WORK_2) WaA and WbA are stored in the virtual box HA. As the absolute coordinate system, the XYZ coordinate system is indicated at the base of the virtual robot arm body 100A. It is only necessary that the absolute coordinate system is indicated at a predetermined position in the virtual space V. With respect to the absolute coordinate system, relative coordinates are set for the respective models and teaching points.

As teaching information for the virtual robot arm body 100A, a teaching point (TP_11) 602a and a teaching point (TP_12) 602b are displayed. The teaching point (TP_11) 602a indicates a pickup position for collecting the virtual workpiece WaA. The teaching point (TP_12) 602b indicates a safe position for pulling the virtual workpiece WaA out of the virtual box HA. Similarly, a teaching point (TP_21) 602c and a teaching point (TP_22) 602d are displayed. The teaching point (TP_21) 602c indicates a pickup position for collecting the virtual workpiece WbA. The teaching point (TP_22) 602d indicates a safe position for pulling the virtual workpiece WbA out of the virtual box HA.

Here, the name in parentheses of each model, teaching point, and coordinates corresponds to a node (item) displayed in the management screen 502. The models, teaching points, and coordinates are managed with the names in parentheses in hierarchical data.

In the management screen 502, the nodes of the elements displayed in the virtual space screen 501 are displayed in a tree structure. Firstly, the node of the absolute coordinate system (ROOT) as the root is displayed, and at its child level, the node of the virtual robot arm body 100A and the node of the virtual box HA are displayed. Because the virtual robot arm body 100A and the virtual box HA are arranged in the absolute coordinate system (ROOT), the virtual robot arm body 100A and the virtual box HA are managed as children of the absolute coordinate system (ROOT) in the hierarchy.

The virtual robot hand body 400A and the TCP 601, which follow the movement of the virtual robot arm body 100A, are displayed as nodes at a child level of the virtual robot arm body 100A.

The virtual workpieces WaA and WbA, which are stored in the virtual box HA and follow the movement of the virtual box HA, are displayed as nodes at a child level of the virtual box HA.

The teaching points 602a and 602b, which are the pickup position and safe position following the movement of the virtual workpiece WaA, are displayed as nodes at a child level of the virtual workpiece WaA. Similarly, the teaching points 602c and 602d, which are the pickup position and safe position following the movement of the virtual workpiece WbA, are displayed as nodes at a child level of the virtual workpiece WbA.

In the simulation screen 500, a cursor 503 is displayed. The cursor 503 is moved by the mouse 304. When a node displayed in the management screen 502 is selected with the cursor 503, a highlight 504 is displayed over the node. Similarly, the highlight 504 is also displayed in the virtual space screen 501 over a model corresponding to the node with the highlight 504. In FIG. 6, the node “BOX” in the management screen 502 and the model of the virtual box HA corresponding to the node “BOX” in the virtual space screen 501 are highlighted. Likewise, when a model in the virtual space screen 501 is selected with the cursor 503, a corresponding node in the management screen 502 is highlighted. When a node or 3D model displayed with the highlight 504 is clicked again, the highlight 504 is removed, and the selection is cancelled.

A toolbar 505 is displayed at the top of the simulation screen 500. In the toolbar 505, a management screen display button 506 for displaying the management screen 502, a partial output button 507 for outputting partial hierarchical data as described later, and a partial input button 508 for inputting (loading) partial hierarchical data as described later are displayed. Additionally, a space change button 509 for changing virtual space data and changing the virtual space is also displayed. The above is the description of the simulation screen 500.

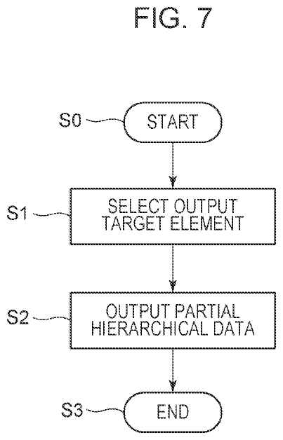

Next, an operation of outputting partial hierarchical data in the present embodiment will be described in detail. FIG. 7 is a control flowchart illustrating a flow of a control procedure implemented by the CPU 312 for the operation of outputting partial hierarchical data. The present embodiment describes a procedure of outputting partial hierarchical data of the virtual box HA and its child elements.

According to the processing procedure in FIG. 7, in step S0, the simulation screen 500 illustrated in FIG. 6 is displayed in response to a predetermined operation performed with the keyboard 303 and the mouse 304. In the present embodiment, the management screen 502 is displayed by clicking the management screen display button 506. In this operation, the CPU 312 reads stored hierarchical data from the ROM 314a or the HDD 314c and accordingly updates the simulation screen 500 to display the management screen 502.

Subsequently, in step S1, an output target element is selected. In the present embodiment, the cursor 503 is operated with the mouse 304 as illustrated in FIG. 6, and the node of the virtual box (BOX) HA displayed in the management screen 502 is selected. In response to the selection operation, the background color of the node of the virtual box (BOX) HA is changed to display the highlight 504 so as to indicate that the virtual box (BOX) HA is being selected.

The 3D model of the virtual box (BOX) HA displayed in the virtual space screen 501 may be selected by the cursor 503 operated by the mouse 304. In this case, the color of the 3D model of the selected virtual box (BOX) HA is changed to display the highlight 504 so as to indicate that the virtual box (BOX) HA is being selected. When a 3D model is selected in the virtual space screen 501, a node in the management screen 502 corresponding to the selected 3D model may be displayed with the highlight 504 at the same time. Conversely, when a node is selected in the management screen 502, a 3D model in the virtual space screen 501 corresponding to the selected node may be displayed with the highlight 504 at the same time.

In the present embodiment, highlighting is grayscaling with the background color. However, highlighting is not limited to changing colors, and it is only necessary to display the node or 3D model in such a manner that it can be determined whether the node or 3D model is being selected.

For example, a mark or pattern may be displayed next to the node in the management screen 502; the size or boldness of characters may be changed; or the design or pattern of the 3D model in the virtual space screen 501 may be changed.

Next, the partial hierarchical data selected in step S1 is outputted. In the present embodiment, the trigger for output is to press the partial output button 507 displayed in the toolbar 505 with the cursor 503 operated by the mouse 304 to start the output operation. However, how to start the operation is not limited to any particular manner, and detailed descriptions thereof is omitted here because the details can be referred to known implementation methods.

When the partial output operation is started, the CPU 312 extracts from the storage device 314 information about the selected node and all the lower-level nodes as children of the selected node. At this time, the CPU 312 calculates the position/orientation data of the 3D model of the extracted virtual box HA as absolute value information with respect to the absolute coordinate system (ROOT). By using the absolute value information, the same position and orientation can be reproduced in the input operation described later. Furthermore, in accordance with the shape information of the virtual box HA, information (for example, position/orientation data) about the lower-level nodes as children can also be extracted as relative values relative to the shape information of the virtual box HA.

After the extraction, the CPU 312 outputs the information about all the extracted nodes, while maintaining the form of hierarchical data, to the file 320 through the interface 315. In the present embodiment, information about the virtual box HA, the virtual workpieces WaA and WbA, and the teaching points 602a, 602b, 602c, and 602d are outputted as hierarchical data. Finally, the output operation ends in step S3.

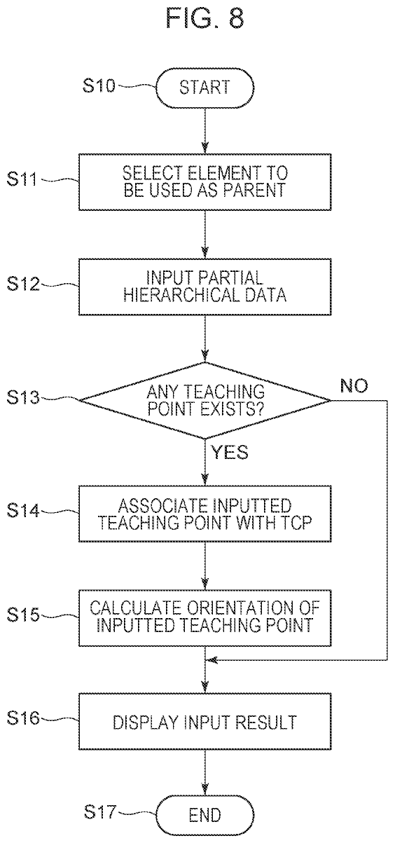

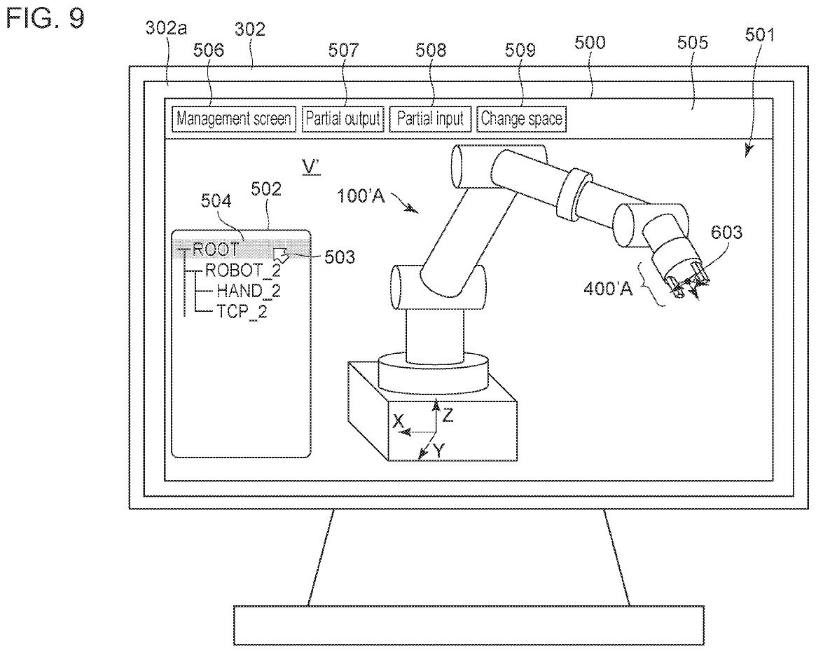

Next, an operation of inputting (loading) partial hierarchical data in the present embodiment will be described in detail. The present embodiment describes as an example the case of using the partial hierarchical data described above in a virtual space V′ represented by second data, which is different from the virtual space V represented by the first data. FIG. 8 is a control flowchart illustrating a control procedure implemented by the CPU 312 for the operation of inputting partial hierarchical data. FIG. 9 illustrates the simulation screen 500 during the operation of inputting partial hierarchical data.

According to FIG. 8, in step S10, a predetermined operation is performed with the information processing apparatus 300, so that the elements illustrated in FIG. 9 are displayed. FIG. 9 illustrates the state in which the virtual space V is deployed by loading data of the virtual space V′ in response to pressing the space change button 509 with the cursor 503 operated by the mouse 304 in the state illustrated in FIG. 6. The virtual space V′ differs from the virtual space V in that a virtual robot arm body (ROBOT_2) 100′A, which is different from the virtual robot arm body (ROBOT_1) 100A, and a virtual robot hand body 400′A, which is different from the virtual robot hand body 400A, are displayed.

In the virtual space screen 501 of the simulation screen 500 in FIG. 9, the virtual robot arm body (ROBOT_2) 100′A, the virtual robot hand body (HAND_2) 400′A, and a TCP (TCP_2) 603 are displayed as 3D model information. By clicking the management screen display button 506, the management screen 502 is displayed, in which the absolute coordinate system (ROOT) as the root and the node of the virtual robot arm body (ROBOT_2) 100′A at its child level are displayed. Additionally, the virtual robot hand body 400′A and the TCP 603, which follow the movement of the virtual robot arm body 100′A, are displayed as nodes at a child level of the virtual robot arm body 100′A.

Next, in step S11, to input the outputted part of the file 320, an element in the virtual space V′ is selected as a parent of the outputted part of hierarchical data. In the present embodiment, the node of the absolute coordinate system (ROOT) displayed in the management screen 502 in FIG. 9 is selected by clicking the node with the cursor 503 operated by the mouse 304.

Subsequently, in step S12, inputting (loading) partial hierarchical data is executed by clicking the partial input button 508 with the cursor 503. When the execution is started, the CPU 312 reads the file 320 and displays as a list the partial hierarchical data stored in the file 320.

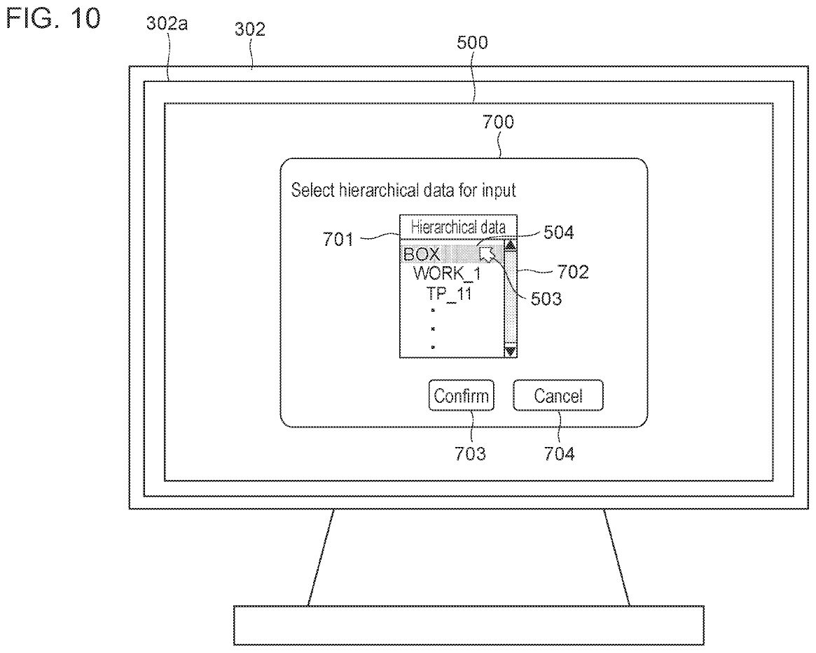

FIG. 10 illustrates a selection screen 700 for selecting hierarchical data to be inputted onto different data in the present embodiment. The selection screen 700 displays a hierarchical data list 701. The hierarchical data list 701 can be scrolled with a scroll bar 702. When an item of hierarchical data in the hierarchical data list 701 is selected with the cursor 503, the highlight 504 is displayed over the selected item of hierarchical data. In FIG. 10, an item of hierarchical data of the virtual box HA, which has been outputted as the partial hierarchical data described above, is selected. In the present embodiment, the name of the information item of the highest parent node in hierarchical data is displayed as the absolute coordinate system (ROOT), the user may change the name into a different name. When a confirmation button 703 is pressed while an item of hierarchical data is being selected, hierarchical data of the virtual box HA, the virtual workpieces WaA and WbA, and the teaching points 602a, 602b, 602c, and 602d is loaded in a given area in the storage device 314 and deployed in the virtual space V′. A cancel button 704 is used to return to the screen for selecting a parent node in FIG. 9. As described above, elements for output can be selected by selecting an item of hierarchical data.

Next, in step S13, it is determined whether the inputted partial hierarchical data includes a node of a teaching point. When no teaching point is included (NO in step S13), an input result is displayed in step S16 described later. When a teaching point is included (YES in step S13), the process moves to step S14.

Subsequently, in step S14, in the case of including teaching points, associations are made between the TCP 603 of the virtual robot arm body 100′A and the teaching points 602a, 602b, 602c, and 602d in the process of the input operation. Associations are made with teaching points that the TCP to be passed over and teaching points at which the orientation of the virtual robot arm body 100′A is calculated in step S15 described later. It is possible to make associations automatically or manually. When associations are made automatically, the TCP 603 at a child level of the virtual robot arm body 100′A, which is displayed in the simulation screen 500 in FIG. 9, is detected. Accordingly, an association is made between the detected TCP 603 and the inputted teaching points 602a, 602b, 602c, and 602d.

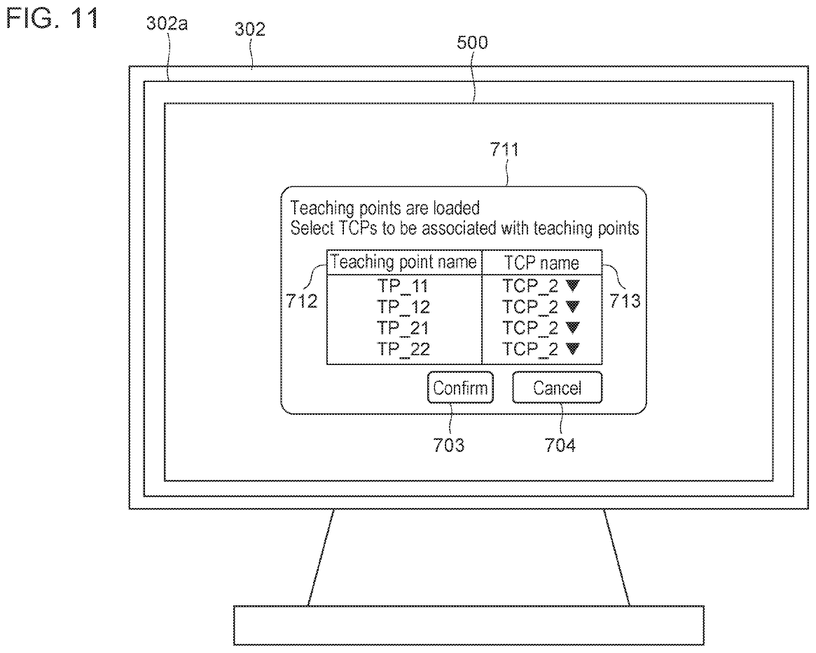

When associations are made manually, a TCP selection screen 711 as illustrated in FIG. 11 is displayed, and associations are made between the TCP 603 and the teaching points 602a, 602b, 602c, and 602d on the TCP selection screen 711. The TCP selection screen 711 in FIG. 11 displays a teaching point list 712 for indicating inputted teaching points and a TCP list 713 for selecting TCPs for the respective inputted teaching points. The teaching points in the teaching point list 712 are in one-to-one correspondence with the TCPs in the TCP list. By clicking a downwards arrow in the TCP list 713, a pull-down menu, which is not illustrated in the drawing, can be used to select TCPs. With this configuration, when a plurality of TCPs are included, associations between the TCPs and teaching points can be made together. Pressing the confirmation button 703 confirms the associations. By pressing the cancel button 704, associations are automatically made.

Next, in step S15, the orientation of the virtual robot arm body 100′A is calculated at the teaching points 602a, 602b, 602c, and 602d. The orientation is calculated with general robotics inverse kinematics; descriptions thereof are omitted because the details can be referred to known implementation methods.

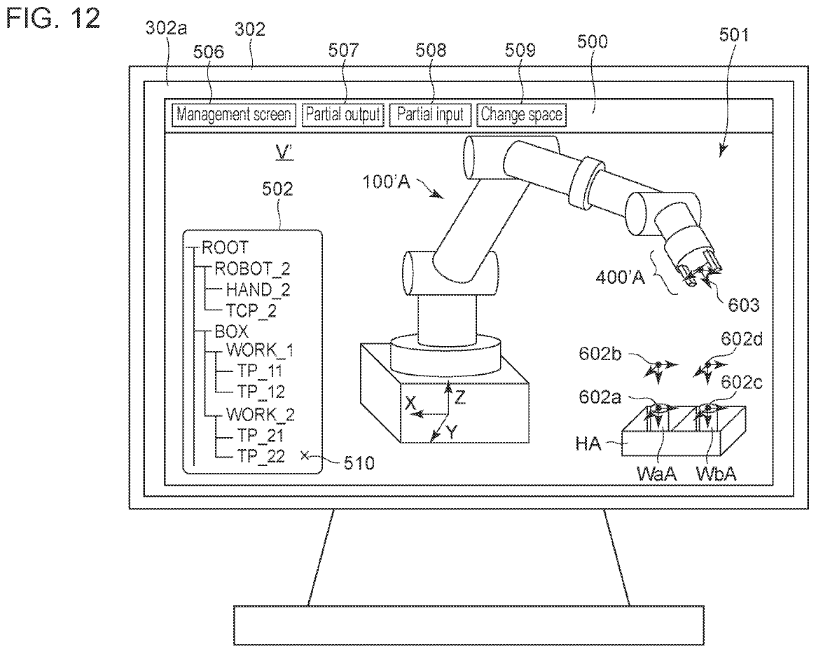

Subsequently, in step S16, an input result is displayed. FIG. 12 illustrates the simulation screen 500 in the state in which an input result is displayed in the virtual space V′. The CPU 312 adds the inputted items of hierarchical data to child nodes of the absolute coordinate system (ROOT) so as to update the virtual space screen 501 and the management screen 502. The updated virtual space screen 501 displays the virtual box HA, the virtual workpieces WaA and WbA, and the teaching points 602a, 602b, 602c, and 602d described above.

Additionally, in the management screen 502, the virtual box (BOX) HA and the elements at a lower level of the virtual box (BOX) HA are restored and displayed in the same tree structure and hierarchy as in the state before the partial output operation. Moreover, as the result of the orientation calculation of teaching points in step S15, when it is discovered that the virtual robot arm body 100′A cannot achieve a particular orientation, the management screen 502 displays an alert indication 510 to provide an alert against the discovery. In the example in FIG. 12, the node of the teaching point 602d is displayed with an alert indication. In the present embodiment the mark of an X is used as the alert indication 510, but other appearances such as coloring characters and the background color in red may be used.

Alternatively, an alert may be provided on the virtual space screen 501 instead of the management screen 502, by changing the state of displaying the 3D model of the teaching point in the virtual space screen 501. An alert may be provided by, for example, changing the appearance of the 3D model of the teaching point by making the 3D model of the teaching point semitransparent, recoloring the 3D model of the teaching point, or changing the pattern of the 3D model of the teaching point, or may be provided by a balloon next to the 3D model.

After the process ends in step S17, the inputted elements can be edited by using the keyboard 303 and the mouse 304.

As described above, with the present embodiment, the created elements targeted for simulation can be processed on different data defining another virtual space. With this configuration, by inputting the partial data of selected elements as hierarchical data, the data can be reused with a simulator of robot system in another virtual space while the relative positions of the selected elements are maintained, and consequently, it is possible to reduce man-hours. When partial hierarchical data includes teaching points, associations are made between the TCP of the virtual robot arm body and the teaching points, the orientation calculation is conducted, and the result is displayed, which are all performed during the input operation. As a result, the state of inputted teaching points can be intuitively checked, and it is possible to further reduce man-hours. When the simulation of taking out operational targets of the same kind stored in the same box is conducted by using a plurality of kinds of robot systems as in the present embodiment, the reuse of data can greatly reduce man-hours.

### Second Embodiment

Next, a second embodiment will be described. In the following, hardware parts and configurations in the control system different from the first embodiment will be illustrated in the diagrams and described as necessary. The same parts as the first embodiment are considered to be implemented by the same configurations and to function in the same manner, and detailed descriptions thereof are not repeated.

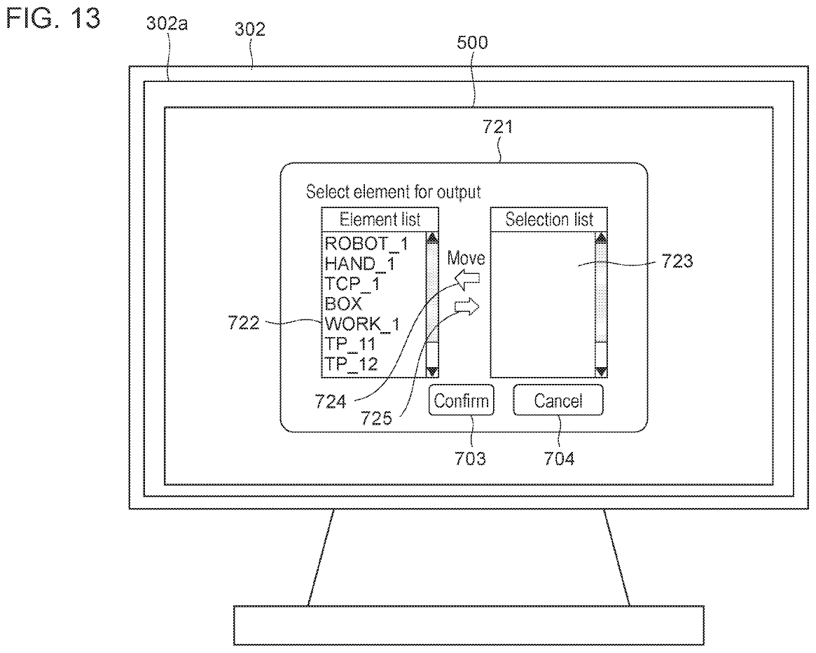

FIG. 13 illustrates a selection screen 721 for selecting elements for output from a list in the present embodiment. The selection screen 721 displays an element list (a list displaying elements to be not outputted) 722 for displaying all elements in the virtual space V. The selection screen 721 also displays a selection list (a list displaying elements to be outputted) 723 for displaying the selection results of elements for output.

The elements are displayed by the name of node in the tree structure displayed in the management screen 502. The selection screen 721 also displays move buttons 724 and 725 for moving elements in the element list 722 and the selection list 723. The move button 724 moves an element from the selection list 723 to the element list 722. The move button 725 moves an element from the element list 722 to the selection list 723. The selection screen 721 also displays the confirmation button 703 for confirming results and the cancel button 704 for terminating the selection operation.

For example, of the child nodes of the virtual box (BOX) HA, when the virtual workpiece (WORK_2) WbA and the teaching points (TP_21, TP_22) 602c and 602d are removed from selections, the process is implemented with the following procedure. The selection operation is performed with the mouse 304 or the keyboard 303.

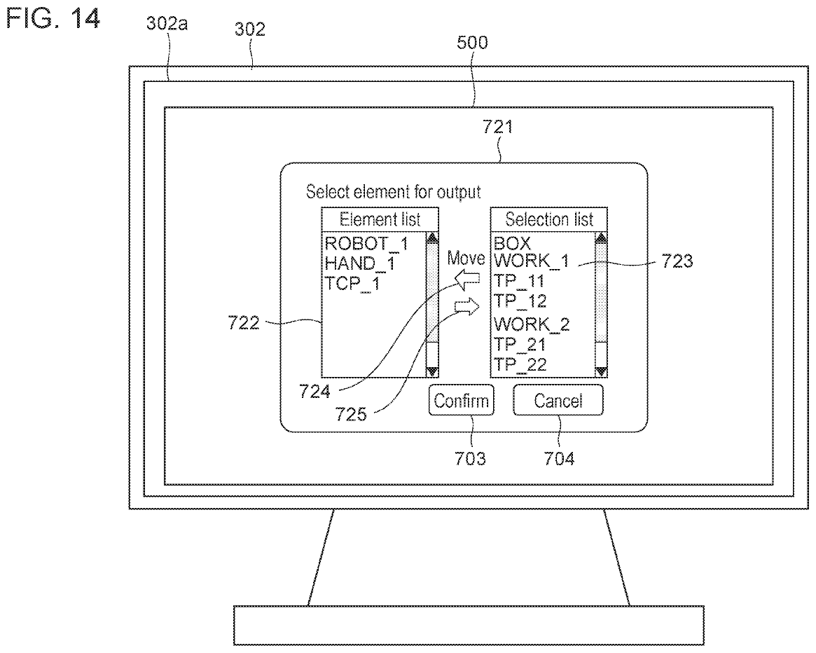

Firstly, the virtual box (BOX) HA is selected as an element for output in the element list 722, and the move button 725 is then pressed. In response to pressing the move button 725, as illustrated in FIG. 14, the selected element and all the child elements of the selected element are moved to the selection list 723, and the names of the nodes of the elements are displayed in the selection list 723. To output the same part of hierarchical data as the first embodiment, the confirmation button 703 is pressed at this stage.

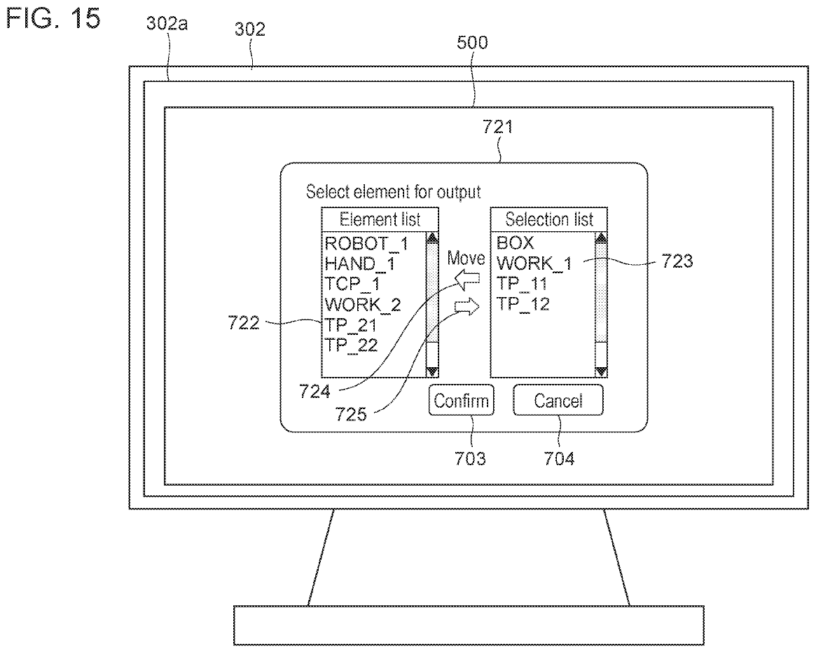

Next, the virtual workpiece (WORK_2) WbA is selected from the elements moved to the selection list 723, and the move button 724 is pressed. In response to pressing the move button 725, as illustrated in FIG. 15, the virtual workpiece WbA and the teaching points 602c and 602d, which are children of the virtual workpiece WbA, are moved to the element list 722. By pressing the confirmation button 703, partial hierarchical data is outputted without the virtual workpiece (WORK_2) WbA and the teaching points (TP_21, TP_22) 602c and 602d of the child nodes of the virtual box (BOX) HA.

With the present embodiment, unnecessary elements can be more easily selected before the output operation are performed, and as a result, the teaching operation can be further reduced. In the present embodiment, elements are moved between the lists while the hierarchy is maintained, but this should not be construed in a limiting sense. For example, the hierarchy may be temporarily removed so that elements can be moved one by one. In this case, it is more effective that selected nodes are highlighted to indicate that a plurality of elements are being selected.

### Third Embodiment

Next, a third embodiment will be described. In the following, hardware parts and configurations in the control system different from the embodiments described above will be illustrated in the diagrams and described as necessary. The same parts as the first embodiment are considered to be implemented by the same configurations and to function in the same manner, and detailed descriptions thereof are not repeated.

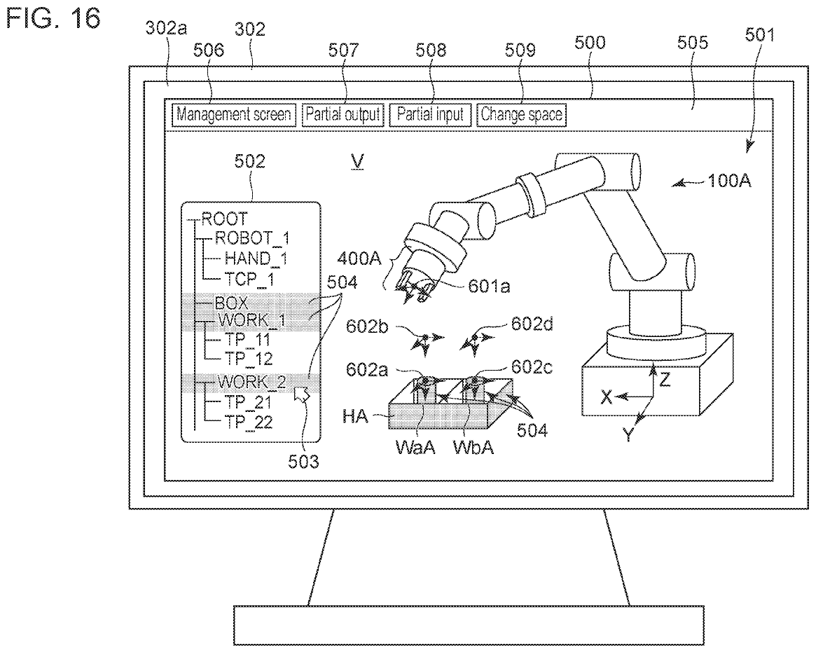

FIG. 16 illustrates the management screen 502 for managing elements in the virtual space V in the present embodiment. In FIG. 16, a plurality of elements are being selected and displayed with the highlight 504 in the management screen 502. The tree structure in the present embodiment is different from the tree structure in the embodiments described above. The hierarchy is constructed such that the virtual robot arm body (ROBOT_1) 100A, the virtual box (BOX) HA, and the virtual workpieces (WORK_1, WORK_2) WaA and WbA are children of the absolute coordinate system (ROOT). With such a hierarchical structure, when it is attempted to partially output the virtual box HA, the virtual workpieces WaA and WbA do not follow the virtual box HA. To tackle this problem, when it is attempted to partially output the absolute coordinate system (ROOT), the virtual robot arm body (ROBOT_1) 100A is also outputted as the part. Hence, a selection operation is performed to select elements for output in accordance with the following procedure.

By clicking with the mouse 304 while holding down the “Ctrl” key on the keyboard 303, a plurality of different elements, for example, the virtual box (BOX) HA and the virtual workpieces (WORK_1, WORK_2) WaA and WbA are selected. The method for selecting a plurality of elements is not limited to this example. A plurality of elements may be selected by, for example, using another key on the keyboard in combination with another pointing device or using the selection screen 721 described in the second embodiment. As the result of the selection operation described above, as illustrated in FIG. 16, the virtual box (BOX) HA and the virtual workpieces (WORK_1, WORK_2) WaA and WbA are displayed with the highlight 504. The models corresponding to the elements selected on the management screen 502 are also displayed with the highlight 504 in the virtual space V. This configuration makes it easier for the user to view which elements are currently selected.

A plurality of elements may be selected by clicking models in the virtual space V with the mouse 304 while holding down the “Ctrl” key on the keyboard 303.

Similarly to the above, corresponding elements may be highlighted on the screen.

Next, the selected elements are outputted as partial hierarchical data. The CPU 312 obtains information about the selected nodes and their child nodes from the storage device 314. At this time, the CPU 312 obtains position/orientation data of the virtual box HA and the virtual workpieces (WORK_1, WORK_2) WaA and WbA as absolute value information in the absolute coordinate system (ROOT). By obtaining absolute value information, the elements can be restored with the same position and orientation as the elements before the output operation. After obtaining the information about the selected nodes and their child nodes, the CPU 312 outputs the information through the interface 315 to the file 320. At this time, the information about the virtual box HA, the virtual workpieces WaA and WbA, and the teaching points 602a, 602b, 602c, and 602d are outputted as hierarchical data to the file 320.

As typical output methods, two cases will be described below with reference to the drawings.

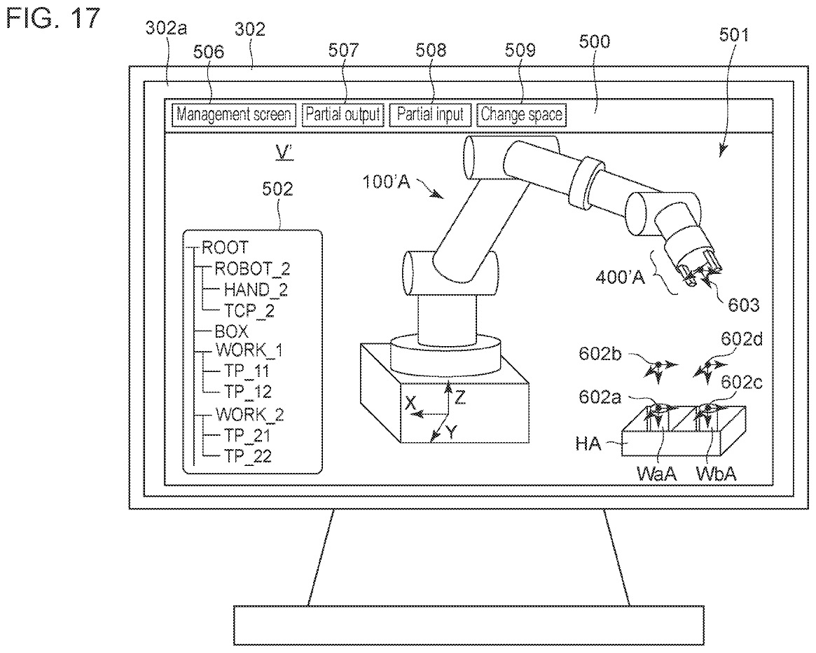

In the first case, the selected elements are outputted as nodes in the same level in the hierarchy (the absolute coordinate system (ROOT) is also regarded as a parent in the virtual space V′). FIG. 17 illustrates the state in which the elements are outputted to the virtual space V′ in the first case. When the elements are outputted in the first case, the virtual box HA and the virtual workpieces WaA and WbA are restored to a child level of the absolute coordinate system (ROOT) in the input operation as illustrated in FIG. 17.

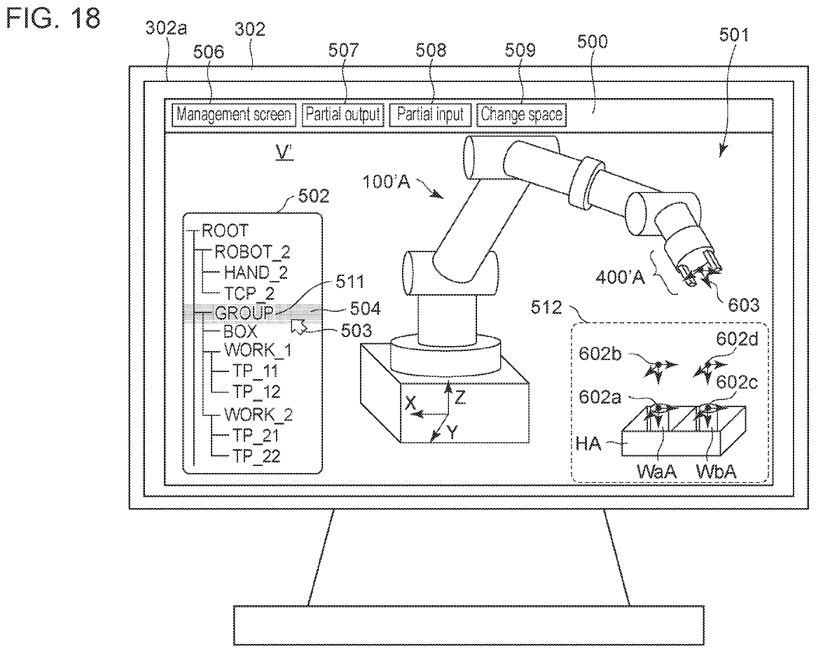

In the second case, a group node for grouping the selected elements is added, and the selected elements are outputted to a child level of the group node. FIG. 18 illustrates the state in which the elements are outputted to the virtual space V′ in the second case. In FIG. 18, a group (GROUP) 511 is displayed in the management screen 502. The node of the group 511 does not have model information. The node of the group 511 is used to aggregate a plurality of elements. When the elements are outputted in the second case, the group 511 is displayed at a child level of the absolute coordinate system (ROOT) in the partial input operation as illustrated in FIG. 18. Additionally, the virtual box HA and the virtual workpieces WaA and WbA are restored to a child level of the group 511. When the group 511 is selected on the management screen 502, the highlight 504 is displayed with the group 511, and a highlight 512 is displayed in the virtual space screen 501 to display in an emphasized manner the models corresponding to the selected group. The present embodiment uses a dashed line as an example of the highlight 512, but this should not be construed in a limiting sense. For example, the highlight 504 may be displayed with all the models of the group.

As described above, in the present embodiment, after the partial input operation, a plurality of elements selected by the group 511 can be processed with their child elements following the elements. Consequently, a plurality of elements not in family relationships (the virtual box HA and the virtual workpieces WaA and WbA) can be outputted together as partial hierarchical data by the grouping operation, which reduces man-hours.

### Fourth Embodiment

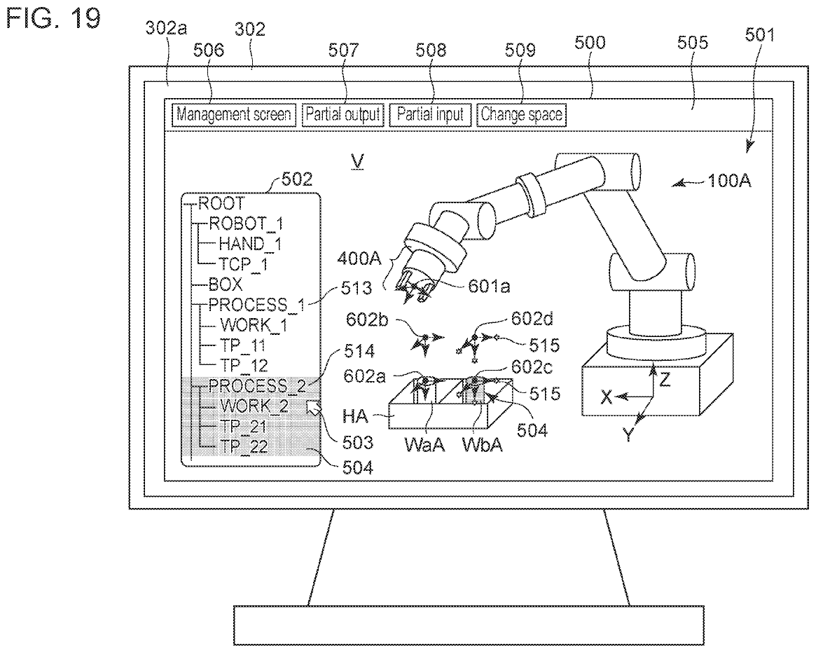

Next, a fourth embodiment will be described. In the following, hardware parts and configurations in the control system different from the embodiments described above will be illustrated in the diagrams and described as necessary. The same parts as the embodiments described above are considered to be implemented by the same configurations and to function in the same manner, and detailed descriptions thereof are not repeated. FIG. 19 illustrates the simulation screen 500 with the virtual space V.

Referring to FIG. 19, in the virtual space screen 501 of the simulation screen 500, the virtual robot arm body (ROBOT_1) 100A, the virtual robot hand body (HAND_1) 400A, and a TCP (TCP_1) 601a are displayed as model information. Additionally, the virtual box (BOX) HA and the two virtual workpieces (WORK_1, WORK_2) WaA and WbA as operational targets are displayed in the state in which the two virtual workpieces (WORK_1, WORK_2) WaA and WbA are stored in the virtual box HA.

As teaching information for the virtual robot arm body 100A, the teaching point (TP_11) 602a and the teaching point (TP_12) 602b are displayed. The teaching point (TP_11) 602a indicates a pickup position for collecting the virtual workpiece WaA. The teaching point (TP_12) 602b indicates a safe position for pulling the virtual workpiece WaA out of the virtual box HA. Similarly, the teaching point (TP_21) 602c and the teaching point (TP_22) 602d are displayed. The teaching point (TP_21) 602c indicates a pickup position for collecting the virtual workpiece WbA. The teaching point (TP_22) 602d indicates a safe position for pulling the virtual workpiece WbA out of the virtual box HA.

The present embodiment differs from the embodiments described above in that, a process node for grouping selected elements is added to the management screen 502, and the nodes of elements relating to the process are associated with a child level of the process node. The process denotes an operation performed by the virtual robot arm body 100A. In FIG. 19, a process (PROCESS_1) 513, which is a process of taking out the virtual workpiece WaA, is displayed. Similarly, a process (PROCESS_2) 514, which is a process of taking out the virtual workpiece WbA, is displayed. The nodes of the processes 513 and 514 do not have model information. The nodes of the processes 513 and 514 are used to group a plurality of elements.

The process 513 is associated with the virtual workpiece WaA and the teaching points 602a and 602b as child nodes in the hierarchy. The process 514 is associated with the virtual workpiece WbA and the teaching points 602c and 602d as child nodes in the hierarchy.

In the simulation screen 500, the cursor 503 is displayed. The cursor 503 is moved by the mouse 304. When a process node displayed in the management screen 502 is selected with the cursor 503, the selected process node and all the child nodes of the process node are displayed with the highlight 504 or a highlight 515. In FIG. 19, the highlight 504 is displayed with the virtual workpiece WbA, whereas the highlight 515 formed as a star is displayed at an end of each of the three axes attached to the teaching points 602c and 602d. Although the highlight 515 is formed as a star in the present embodiment, any shape, such as a rectangle, a circle, or a triangle, may be used. When the process node displayed with the highlight 504 is clicked again, the highlight 504 is removed, and the selection is cancelled.

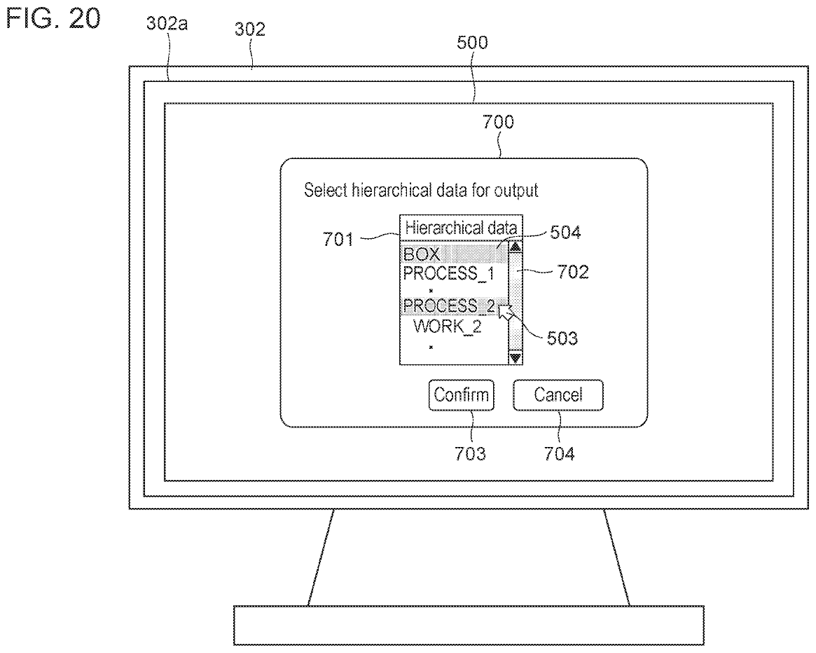

FIG. 20 illustrates the selection screen 700 for selecting hierarchical data in the present embodiment. The selection screen 700 displays the hierarchical data list 701. The hierarchical data list 701 can be scrolled with the scroll bar 702. When an item of hierarchical data in the hierarchical data list 701 is selected with the cursor 503, the highlight 504 is displayed over the selected item of hierarchical data. In the state in FIG. 20, items of hierarchical data of the virtual box HA and the process 514 are selected. When the confirmation button 703 is pressed while the elements is being selected, hierarchical data of the virtual box HA, the virtual workpiece WaA, and the teaching points 602c and 602d is loaded in a given area in the storage device 314 and deployed in the virtual space V′. The cancel button 704 is used to return to the screen for selecting a parent node. The selection screen in the second embodiment may be used.

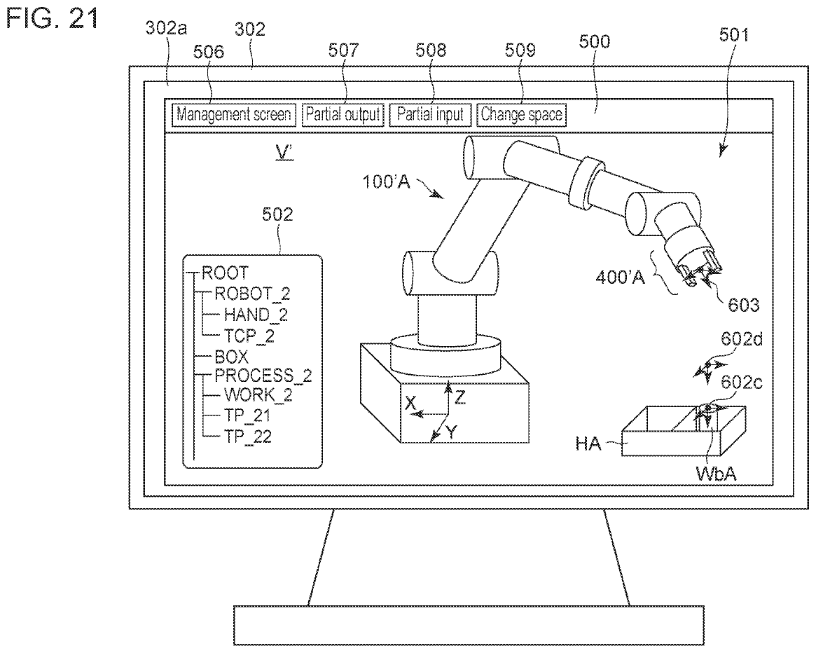

FIG. 21 illustrates the simulation screen 500 in the state in which partial input results are displayed in the virtual space V′ after associations are made with teaching points as in the embodiment described above. The CPU 312 adds the inputted items of hierarchical data to child nodes of the absolute coordinate system (ROOT) so as to update the virtual space screen 501 and the management screen 502. The updated virtual space screen 501 displays the virtual box HA, the virtual workpiece WbA, and the teaching points 602c and 602d described above.

Additionally, in the management screen 502, the process (PROCESS_2) 2 and the elements at a lower level of the process (PROCESS_2) 2 are restored and displayed in the same tree structure and hierarchy as in the state before the partial output operation.

As described above, in the present embodiment, elements can be collectively extracted for different processes (operations) performed by the virtual robot arm. In particular, when there are many virtual workpieces and many teaching points due to the complexity of operation, elements can be partially displayed in an emphasized manner, and elements can be inputted and outputted between different sets of space data as in the present embodiment. This can greatly reduce man-hours.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)?), a flash memory device, a memory card, and the like.

Specifically, control devices, or an information processing apparatus, execute the processing procedures of the embodiments described above. Hence, the processing procedures can be configured to be executed by a CPU, which centrally performs processing, that reads and runs a software program for implementing the functions described above, stored in a recording medium supplied to the apparatus integrating the control devices. In this case, the program read from the recording medium realizes the functions of the embodiments described above, and thus, the program and the recording medium storing the program are embodied in the present disclosure.

The embodiments have described the case in which, the computer-readable recording medium is a ROM, RAM, or flash memory, and the ROM, RAM, or flash memory stores the program. The present disclosure is, however, not limited to these examples. The program for implementing the present disclosure can be stored in any kind of recording medium when the recording medium is computer-readable. As the recording medium for supplying the control program, for example, an HDD, external storage device, or recording disk may also be used.

The embodiments described above have described the case in which the robot arm body is an articulated robot arm having a plurality of joints, the number of joints is not limited to this example. Although the robot arm is formed in a vertical multiple-axis structure, the same configurations can be implemented with other kinds of joint structures, such as a horizontally articulated structure, a parallel link structure, and a Cartesian coordinate robot.

The embodiments described above have described as an example the case of grasping a workpiece W as an operation with the workpiece W, but this should not be construed in a limiting sense. Various motions such as coating, welding, cutting, fastening with, for example, screws, and polishing can be performed.

The embodiments described above can be applied to machines capable of automatically performing extending and retracting, bending and stretching, moving upwards and downwards, moving to left and right, or rotating, or a combination thereof in accordance with information in the storage device provided in the control device.

The present disclosure is not limited to the embodiments described above, and various modifications to the embodiments may be made without departing from the technical idea of the present disclosure. The embodiments of the present disclosure have only described the most desired effects achieved with the present disclosure, and effects of the present disclosure are not limited to the effects described in the embodiments of the present disclosure. It is also possible to combine together at least two or more of the embodiments described above.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-104985 filed Jun. 24, 2021, which is hereby incorporated by reference herein in its entirety.

What is claimed is:

1. An information processing apparatus comprising:
a display unit configured to display a state of a robot system based on first data,
wherein at least one element of the robot system based on the first data is outputted with second data different from the first data.

2. The information processing apparatus according to claim 1, wherein
the at least one element includes a plurality of elements, and the plurality of elements includes a first element at a higher level and a second element at a lower level of the first element in a hierarchy.

3. The information processing apparatus according to claim 2, wherein
of the at least one element, one or more given elements managed in a hierarchy are outputted.

4. The information processing apparatus according to claim 2, wherein
a first screen configured to display a name of the at least one element as a node and a second screen configured to display the at least one element as a model are displayed.

5. The information processing apparatus according to claim 4, wherein
when a node or model is selected on a corresponding one of the first screen and the second screen, a corresponding node or model is displayed with a highlight on another of the first screen and the second screen.

6. The information processing apparatus according to claim 5, wherein
an element for output of the at least one element is selected on the first screen or the second screen.

7. The information processing apparatus according to claim 6, wherein
the selected element is displayed with a highlight on the first screen and/or the second screen.

8. The information processing apparatus according to claim 4, wherein
when a node or model representing the first element is selected on a corresponding one of the first screen and the second screen, a corresponding node or model representing the first element and a node or model representing the second element are displayed with a highlight on another of the first screen and the second screen.

9. The information processing apparatus according to claim 8, wherein
the highlight is provided by changing a color of the model or a background color of the node.

10. The information processing apparatus according to claim 2, wherein
a robot arm and a robot hand are configured in the robot system, and
the first element is the robot arm, and the second element is the robot hand.

11. The information processing apparatus according to claim 10, wherein
a control point is configured at the robot hand, and
the second element includes the control point.

12. The information processing apparatus according to claim 11, wherein
the control point and/or the teaching point are indicated by a coordinate system having three axes, and
when the control point or the teaching point are displayed with a highlight, a predetermined shape is displayed at an end of each of the three axes.

13. The information processing apparatus according to claim 2, wherein
a target object and a teaching point for performing an operation with the target object are configured in the robot system, and
the first element is the target object, and the second element is the teaching point.

14. The information processing apparatus according to claim 13, wherein
when the at least one element based on the first data is outputted with the second data, a third screen configured for associating a control point based on the second data with the teaching point.

15. The information processing apparatus according to claim 14, wherein
the control point is displayed in a pull-down menu on the third screen.

16. The information processing apparatus according to claim 13, wherein
a first robot is configured in the robot system, and a second robot different from the first robot is configured with the second data, and
an indication of whether the second robot is capable of performing an operation at the teaching point with the second data is displayed.

17. The information processing apparatus according to claim 2, wherein
a target object and a teaching point for performing an operation with the target object are configured in the robot system, and
the first element is an operation, and the second element is the target object and the teaching point.

18. The information processing apparatus according to claim 2, wherein
a fourth screen configured for selecting an element for output of the at least one element from a unit of given elements managed in a hierarchy of the at least one element is displayed.

19. The information processing apparatus according to claim 18, wherein
the fourth screen is displayed as a list.

20. The information processing apparatus according to claim 18, wherein
the fourth screen displays a first area for displaying an element to be outputted and a second area for displaying an element to be not outputted, and
an element for output of the at least one element is selected by moving given elements of the at least one element between the first area and the second area.

21. The information processing apparatus according to claim 2, wherein
the outputted at least one element is deployed with the second data different from the first data, and
the first element is associated with an element of the second data while the hierarchy is maintained.

22. The information processing apparatus according to claim 1, wherein
the first data is a first space data, and the second data is a second space data, and
the outputted at least one element is deployed with the second space data.

23. The information processing apparatus according to claim 1, wherein
an element for output of the at least one element is outputted with a new element added to create a group in a hierarchy.

24. The information processing apparatus according to claim 23, wherein
elements grouped in a hierarchy of the at least one element are displayed with a highlight by circling the elements with a line.

25. A robot system comprising the information processing apparatus according to claim 1.

26. An article manufacturing method for manufacturing an article by using the robot system according to claim 25.

27. An information processing method for displaying a state of a robot system based on first data, wherein
at least one element of the robot system based on the first data is displayed with second data different from the first data.

28. A display device configured to display a state of a robot system based on first data, wherein
at least one element of the robot system based on the first data is displayed with second data different from the first data.

29. A display method for displaying a state of a robot system based on first data, comprising:
displaying at least one element of the robot system based on the first data, with second data different from the first data.

30. A non-transitory computer-readable recording medium storing a program implementing the information processing method according to claim 27.
